(19) United States
(12) Patent Application Publication
(10) Pub. No.: US 2023/0192228 A1
(43) Pub. Date: Jun. 22, 2023

(54) Secure Bicycle Drop-Out

(71) Applicants: James P. JOHNSON, Springfield, OR (US); Paul E. JOHNSON, Springfield, OR (US)

(72) Inventors: James P. JOHNSON, Springfield, OR (US); Paul E. JOHNSON, Springfield, OR (US)

(21) Appl. No.: 17/559,849

(22) Filed: Dec. 22, 2021

(51) Int. Cl. B62K 25/02; B62K 3/02; F16B 1/02

(52) U.S. Cl. CPC B62K 25/02; B62K 3/02; F16B 1/02

(57) ABSTRACT

Bicycle dropouts to secure a rear axle of a bicycle include a dropout with locking channels formed over a portion of its face, and a corresponding locking plate with complementary channels formed over one face. The locking plate surrounds the rear axle and the locking and complementary channels engage to prevent the rear axle from moving in the dropout. When the locking plate is loosened so that the channels can disengage, the rear axle position can be adjusted forward and backward to loosen or tighten the chain.

### CONTINUITY AND CLAIM OF PRIORITY

This is an original U.S. patent application.

### FIELD

The invention relates to bicycle frame components. More specifically, the invention relates to rear-wheel dropouts that hold the rear wheel’s axle securely in severe duty situations.

### BACKGROUND

Bicycles are comprised of a number of parts (wheels, handlebars, brakes, pedals, seat) secured to each other and to a frame. Many parts are secured by simple friction clamping (e.g., the seat post is often clamped into a concentric seat tube of the frame). Friction clamping is simple, inexpensive, and can permit easy fine adjustment.

Some bicycle parts experience significant stresses in use, particularly during competition and in certain styles of riding. Downhill racing and BMX trick riding in particular present challenges to bicycle components and securing mechanisms.

One joint where a conventional friction clamp is often used, but can fail under hard service, is the rear axle to frame connection. A conventional rear axle is clamped into the frame by threaded fasteners (nuts) or by a cam-operated quick-release spindle. But hard landings after jumps or tricks can knock the axle out of position, resulting in a crooked rear wheel and poor or unexpected bicycle behavior.

Sophisticated mechanisms (often modeled after motorcycle rear-wheel connections) can hold a bicycle rear wheel securely, but these mechanisms are often expensive or heavy. An alternate solution to hold a bicycle rear wheel securely that is lighter and less expensive may be of significant value in this field.

### SUMMARY

Embodiments of the invention are bicycle rear-wheel dropouts having a longitudinal slot to permit adjustment of the rear wheel axle, with a plurality of grooves oriented roughly perpendicular to the slot; and locking plates having a plurality of complementary grooves, where the locking plate is placed around the rear wheel axle and secured against the grooves of the dropouts to hold the axle securely in place.

### BRIEF DESCRIPTION OF DRAWINGS

FIG. 1 shows a representative bicycle comprising an embodiment of the invention.

FIG. 2 shows a prior-art bicycle dropout.

FIG. 3 shows an embodiment of the invention, with two different lock plates that could be used.

FIG. 4 shows another embodiment of the invention with different complementary grooves.

FIG. 5 shows how a dropout according to an embodiment of the invention engages with a corresponding lock plate.

### DETAILED DESCRIPTION

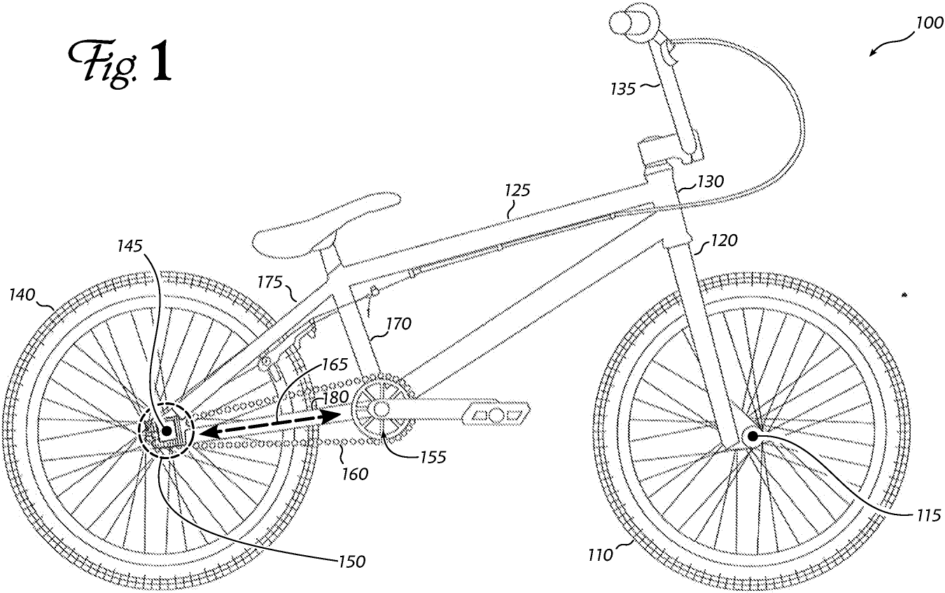

FIG. 1 shows a representative bicycle 100 that has been fitted with an embodiment of the invention. This figure provides an overview of parts and elements that will be referred to in the subsequent discussion; other drawings will show characteristics of embodiments in greater detail, but may refer to items only shown in this overview.

Chain-driven bicycle 100 comprises a front wheel 110, which rotates about a front axle 115. The front axle is secured to the fork 120. The fork is coupled to the frame 125 at the head tube 130. Handlebars 135 are coupled to the fork 120.

At the rear of the bicycle, a rear wheel 140 rotates about a rear axle 145, which is secured to the frame 125 between right and left dropouts (circled at 150). A driven sprocket is coupled to the rear wheel and concentric about the rear axle, but is not clearly visible and therefore is not identified in this view.

A driving sprocket 155 carries a chain 160, which loops around the driven sprocket near the rear axle 145. The driving and driven sprockets and the chain are arranged so that adjusting the position of rear axle 145 along an adjustment direction 165 can loosen or tighten the chain.

The rear portion of frame 125 is made up of a seat tube 170 and pairs of seat stays 175 and chain stays 180. The rear dropout, chain stay and seat stay on either side of the rear wheel 140 form a triangle, with the seat tube 170 forming a common forward edge of the left and right triangles. Bicycle frames are often constructed of appropriately-sized tubing welded together at joints. Many of these joints include a fitting or bracket brazed or welded to the tubes. For example, the head tube typically includes bearing races to allow the fork to turn smoothly, and a pedal-operated bicycle conventionally includes a large “bottom” bracket to support a crankshaft extending from the left crank and pedal through to the right crank and pedal.

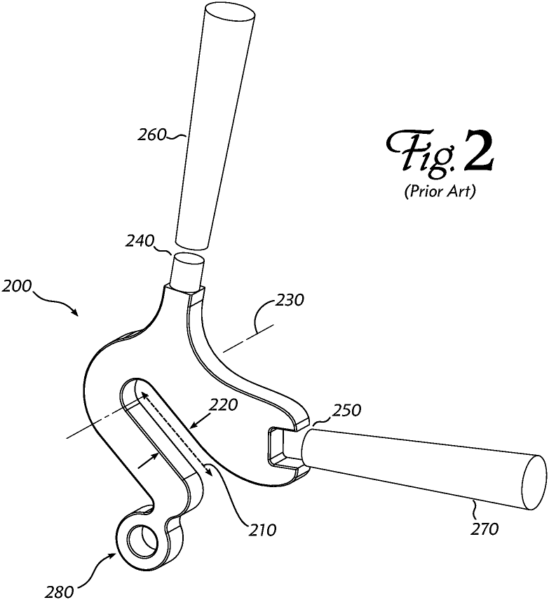

Embodiments of the invention form part of the frame of a bicycle near the junction of the chainstay, seat stay, and rear axle, at a part conventionally known as a “dropout.” FIG. 2 shows an example prior-art dropout 200. Its shape defies simple description, but the significant features for understanding the import of the present invention include a parallel-sided slot (dashed line 210), whose width 220 is adequate to accept the rear axle (axle centerline indicated at 230) and to allow the rear wheel to slide in and out of the rear triangle of the bicycle. The dropout comprises mounting features 240, 250, which facilitate the use of the dropout in a weldment with the seat stay 260 and chainstay 270. Dropouts may comprise other features, such as a derailleur hanger 280.

This figure shows two different types of mounting features: a cylindrical boss 240, suitable for inserting inside a tubular seat stay; and a notch 250, into which a tubular chainstay may be inserted. Typically, both mounting features of a single dropout are similar, rather than heterogenous as shown here. Dropouts may be cast or drop-forged, machined from billet, or stamped or cut by saw, waterjet or laser from a sheet or bar of strong material that is compatible with the process used to secure the dropout to the rest of the frame.

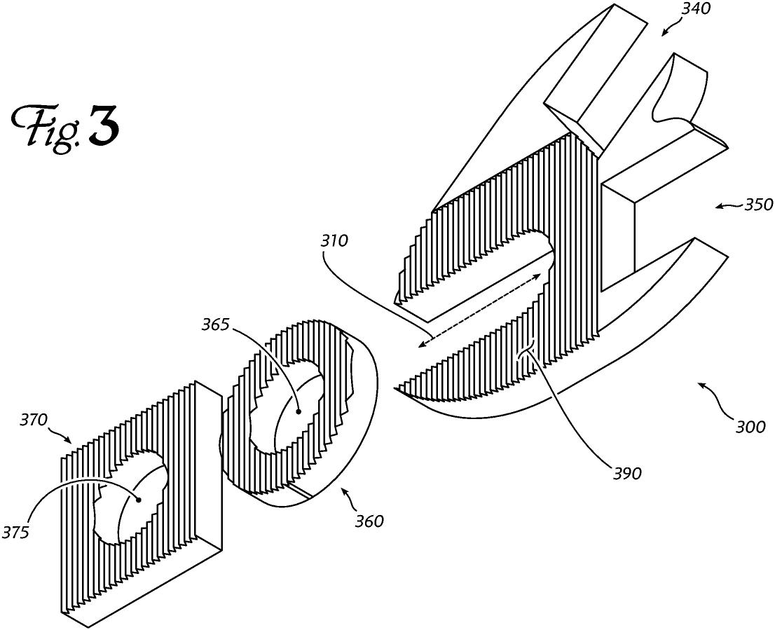

FIG. 3 shows a dropout according to an embodiment of the invention, 300. This dropout is shaped differently from the conventional one shown in FIG. 2, but it comprises several corresponding features: mounting features 340 and 350, to secure the dropout to seat and chainstays, respectively; and a parallel-sided slot 310 (dashed line) whose width is adequate to accept the rear axle and allow the rear wheel to be positioned in (and removed from) the rear triangle.

An embodiment further comprises a locking plate, which may be in the general shape of a washer 360, or a different shape 370. The locking plate has an opening (365 or 375) which is large enough to accept the rear axle. Further, in an embodiment of the invention, at least a portion of one face of the dropout 300 is provided with grooves, serrations or locking channels 390. Complementary grooves, serrations or locking channels are formed on at least one face of the locking plates. When the bicycle is assembled, the channeled faces of the dropout and the locking plates are placed adjacent each other and urged into contact by a threaded fastener on the rear axle, by a “quick-release” spindle through the rear axle, or by another similar mechanism. When the rear wheel is secured into the dropout, then, the mating serrations of the dropout and the locking plate prevent the rear axle from sliding forward or backward in the parallel-sided slot. This is important for a bicycle whose rear wheel is subjected to extreme stresses, such as in downhill racing or BMX trick riding.

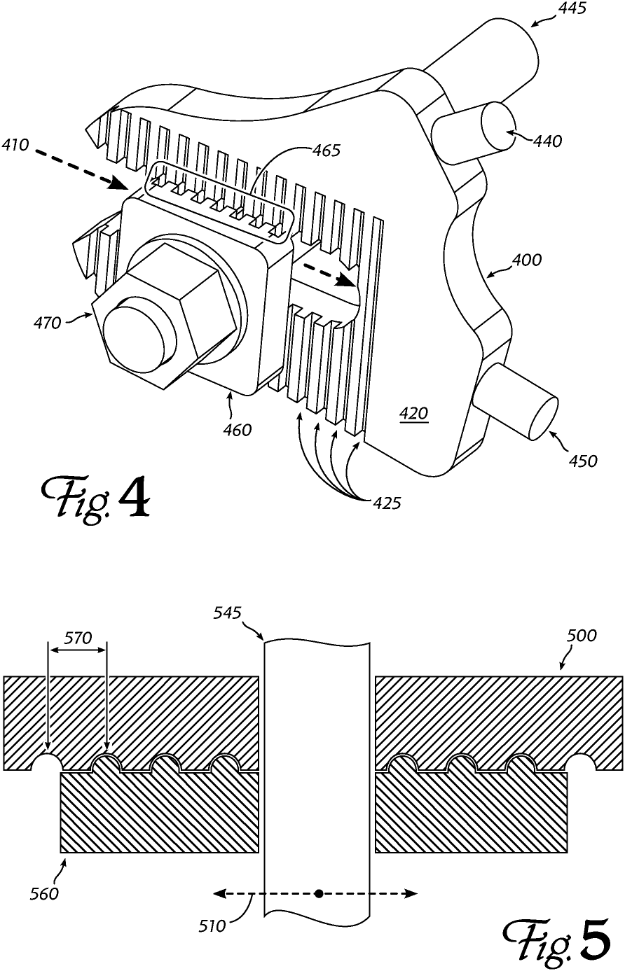

FIG. 4 shows another embodiment of the invention, with the components more closely assembled in their final positions. The main body of the dropout, 400, may be cut from a length of bar or sheet stock of predetermined thickness in the shape shown. The main body is formed with a parallel-sided slot 410 whose width is sufficient to admit a rear axle 445 and allow the rear axle to slide forward and backward along the slot. The main body 400 includes engagement points at 440 for the seat stay and at 450 for the chainstay. The outer face 420 has channels 425 formed across it, adjacent to the slot (on both sides thereof). These channels are preferably approximately perpendicular to the length of the slot 410.

The embodiment comprises a locking plate 460, which has a hole large enough to admit the rear axle 445 and a plurality of complementary channels across one face (the channeled face is oriented away from the viewer in this figure, but the edges of the complementary channels can be seen at 465). A threaded fastener (nut) 470 can be tightened onto the axle 445 to urge the locking plate 460 against the dropout 400. When the complementary channels are engaged, the rear axle 445 is prevented from moving back and forth in the slot 410. The channels in the dropout face 420 and the locking plate may be square or trapezoidal.

FIG. 5 is a cross-section view of the grooved portion of a dropout according to an embodiment of the invention, 500, with the locking plate 560 engaged via complementary serrated grooves. Rear axle 545 may move forward or aft in the dropout slot, 510, but only in discrete units of distance 570 which corresponds to the period or pitch of the complementary grooves. Since moving the axle forward or aft loosens or tightens the chain, respectively, it is preferred that the groove pitch be a fraction of the chain pitch. For example, if the groove pitch is ½ of the chain pitch, then the chain tightness can be adjusted in ¼-link units (because the chain is looped, longitudinal adjustment of the rear axle position is divided between the upper and lower runs of the chain). Narrower groove pitch permits finer chain tension adjustments, but the interlocking features are smaller, more difficult to manufacture, and of reduced strength. A good balance between chain tension adjustability and groove sturdiness is found with a groove pitch between about ¼ chain link length and about ¾ chain link length.

In similar fashion, the depth of the interlocking channels may be of similar dimension to the pitch of the grooves, or somewhat less than the groove pitch. Deeper grooves are more difficult to manufacture, with limited benefits. Grooves that are too shallow may not provide enough resistance to rear axle movement.

The applications of the present invention have been described largely by reference to specific examples and in terms of particular allocations of functionality to certain physical features of embodiments. However, those of skill in the art will recognize that bicycle rear axles can be held securely and adjustably by components that achieve the effects of the present invention differently than the embodiments depicted in the figures. Such variations and alternate structures are understood to be captured according to the following claims.

We claim:

1. A rear-wheel securing assembly for a bicycle, comprising:
two dropouts, each having a slot to permit longitudinal adjustment of an axle of a rear wheel of a bicycle traveling along the slot, a first of the two dropouts secured to a left side of a bicycle frame and a second of the two dropouts secured to a right side of the bicycle frame, wherein
each of the two dropouts comprises a plurality of grooves oriented substantially perpendicularly to the slot of the dropout; and
two washers, each having a hole large enough to admit the axle of the rear wheel, wherein
one face of each of the two washers comprises a plurality of complementary grooves, said complementary grooves configured to mate with the plurality of grooves in the two dropouts.

2. The rear-wheel securing assembly of claim 1 wherein a pitch of the plurality of grooves is between ¼ and ¾ of a length of a link of a chain of the bicycle.

3. The rear-wheel securing assembly of claim 1 wherein a depth of the plurality of grooves is less than a pitch of the plurality of grooves and greater than half of the pitch of the plurality of grooves.

4. The rear-wheel securing assembly of claim 1 wherein an outer perimeter of the washers is circular.

5. The rear-wheel securing assembly of claim 1 wherein an outer perimeter of the washers is square.

6. A metal object cut from bar or sheet stock of predetermined thickness, said object having:
an engagement point for a chainstay of a bicycle;
an engagement point for a seat stay of the bicycle;
a parallel-sided slot having a width no less than a diameter of an axle of a rear wheel for the bicycle, and a length; and
a plurality of serrations across a face of the object, said serrations being adjacent the parallel-sided slot and oriented perpendicular to the length of the parallel-sided slot.

7. The metal object of claim 6 wherein the engagement point for the chainstay of the bicycle is a protrusion configured to fit inside a tubular chainstay.

8. The metal object of claim 6 wherein the engagement point for the chainstay of the bicycle is a notch sized to accept an outer surface of the chainstay.

9. The metal object of claim 6 wherein the plurality of serrations are a plurality of triangular grooves.

10. The metal object of claim 6 wherein the plurality of serrations are a plurality of square or trapezoidal grooves.

11. The metal object of claim 6 wherein the plurality of serrations are a plurality of semicircular grooves.

12. The metal object of claim 6 wherein a depth of the plurality of serrations is about equal to a pitch of the plurality of serrations.

13. The metal object of claim 6 wherein a depth of the plurality of serrations is greater than half of a pitch of the plurality of serrations and less than the pitch of the plurality of serrations.

14. A chain-driven bicycle, comprising:
a frame;
a fork coupled to a front portion of the frame;
a front wheel having a front axle, said front axle secured to the fork;
handlebars coupled to the fork;
a rear wheel having a rear axle, said rear axle secured to a rear portion of the frame at right and left dropouts;
a driven sprocket coupled to the rear wheel;
a driving sprocket;
a chain connecting the driving sprocket to the driven sprocket, wherein
the driving sprocket and the driven sprocket are arranged so that adjusting a position of the rear axle along an adjustment direction is operative to change a tension of the chain;
the right and left dropouts characterized by comprising:
a parallel-sided slot having a width large enough to accept an end of the rear axle and a length, said length generally parallel to the adjustment direction;
a plurality of locking channels oriented generally perpendicular to the adjustment direction; the chain-driven bicycle further comprising:
right and left rear-axle lock plates, each lock plate having an opening large enough to accept an end of the rear axle and a channeled face comprising mating channels configured to engage with the plurality of locking channels of the respective right and left dropouts; and
means for urging the right and left threaded rear-axle lock plates against the right and left dropouts so that the mating channels engage the locking channels and discourage the rear axle from traveling along the length of the parallel-sided slot.

15. The chain-driven bicycle of claim 14 wherein the locking channels and the mating channels are triangular in shape.

16. The chain-driven bicycle of claim 14 wherein the locking channels and the mating channels are square in shape.

17. The chain-driven bicycle of claim 14 wherein the locking channels and the mating channels are trapezoidal in shape.

18. The chain-driven bicycle of claim 14 wherein the locking channels and the mating channels are semicircular in shape.

19. The chain-driven bicycle of claim 14 wherein a pitch of the locking channels and the mating channels is between ¼ of a length of a link of a chain of the chain-driven bicycle and ¾ of the length of the link of the chain of the chain-driven bicycle.

20. The chain-driven bicycle of claim 14 wherein a depth of the locking channels and the mating channels is at least half of a pitch of the locking channels and the mating channels, and no greater than the pitch of the locking channels and the mating channels.
